(19) United States
(12) Patent Application Publication
(10) Pub. No.: US 2009/0190845 A1
(43) Pub. Date: Jul. 30, 2009

(54) MOTION-COMPENSATED RESIDUE BASED TEMPORAL SEARCH RANGE PREDICTION

(75) Inventors: Oscar Chi Lim Au, Hong Kong (CN); Liwei Guo, Hong Kong (CN)

Correspondence Address: TUROCY & WATSON, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/019,067

(22) Filed: Jan. 24, 2008

(51) Int. Cl. G06K 9/36

(52) U.S. Cl. 382/236

(57) ABSTRACT

Efficient temporal search range predication for motion estimation in video coding is provided where complexity of using multiple reference frames in multiple reference frame motion estimation (MRFME) can be evaluated over a desired performance level. In this regard, a gain can be determined for using regular motion estimation or MRFME, and a number of frames if the latter is chosen. Thus, the computational complexity of MRFME and/or a large temporal search range can be utilized where it provides at least a threshold gain in performance. Conversely, if the complex calculations of MRFME do not provide sufficient benefit to the video block prediction, a smaller temporal search range (a less number of reference frames) can be used, or regular motion editing can be chosen over MRFME.

### TECHNICAL FIELD

The following description relates generally to digital video coding, and more particularly to techniques for motion estimation using one or more reference frames of a temporal search range.

### BACKGROUND

The evolution of computers and networking technologies from high-cost, low performance data processing systems to low cost, high-performance communication, problem solving, and entertainment systems has increased the need and desire for digitally storing and transmitting audio and video signals on computers or other electronic devices. For example, everyday computer users can play/record audio and video on personal computers. To facilitate this technology, audio/video signals can be encoded into one or more digital formats. Personal computers can be used to digitally encode signals from audio/video capture devices, such as video cameras, digital cameras, audio recorders, and the like. Additionally or alternatively, the devices themselves can encode the signals for storage on a digital medium. Digitally stored and encoded signals can be decoded for playback on the computer or other electronic device. Encoders/decoders can use a variety of formats to achieve digital archival, editing, and playback, including the Moving Picture Experts Group (MPEG) formats (MPEG-1, MPEG-2, MPEG-4, etc.), and the like.

Additionally, using these formats, the digital signals can be transmitted between devices over a computer network. For example, utilizing a computer and high-speed network, such as digital subscriber line (DSL), cable, T1/T3, etc., computer users can access and/or stream digital video content on systems across the world. Since the bandwidth for such streaming is typically not as large as local access and because processing power is ever-increasing at low costs, encoders/decoders often attempt to require more processing during the encoding/decoding steps to decrease the amount of bandwidth required to transmit the signals.

Accordingly, encoding/decoding methods have been developed, such as motion estimation (ME), to provide pixel or region prediction based on a previous reference frame, thus reducing the amount of pixel/region information that should be transmitted across the bandwidth. Typically, this requires encoding of only a prediction error (e.g., a motion-compensated residue). Standards such as H.264 have been released to extend temporal search ranges to multiple previous reference frames (e.g., multiple reference frames motion estimation (MRFME)). However, as the number of frames utilized in MRFME increase, so does its computational complexity.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Variable frame motion estimation in video coding is provided where the gain of using single reference frame motion estimation (ME) or multiple reference frame motion estimation (MRFME), and/or a number of frames in MRFME can be determined. Where the gain meets or exceeds a desired threshold, the appropriate ME or MRFME can be utilized to predict a video block. The gain determination or calculation can be based on a linear model of motion-compensated residue over the evaluated reference frames. In this regard, performance gain of utilizing MRFME can be balanced with the computational complexity thereof to produce an efficient manner of estimating motion via MRFME.

For example, beginning with a first reference frame prior in time to the video block to be evaluated, if the motion-compensated residue of the reference frame, as compared to the video block, meets or exceeds a given gain threshold, MRFME can be performed, as opposed to regular ME. If motion-compensated residue of a subsequent reference frame, as compared to the previous reference frame, meets the same or another threshold, the MRFME can be performed with an additional reference frame, and so on until the gain of adding additional frames is no longer justified by the computational complexity of MRFME according to the given threshold.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that estimates motion for encoding video.

FIG. 2 illustrates a block diagram of an exemplary system that measures gain of using one or more reference frames to estimate motion.

FIG. 3 illustrates a block diagram of an exemplary system that calculates a motion vector of a video block and determines gain of using one or more reference frames to estimate motion for the video block.

FIG. 4 illustrates a block diagram of an exemplary system that utilizes inference to estimate motion and/or encode video.

FIG. 5 illustrates an exemplary flow chart for estimating motion based on a gain of utilizing one or more reference frames.

FIG. 6 illustrates an exemplary flow chart for comparing residue energy of one or more video blocks to determine a temporal search range.

FIG. 7 illustrates an exemplary flow chart for determining a temporal search range based on a calculated gain of using one or more reference frames for motion estimation.

FIG. 8 is a schematic block diagram illustrating a suitable operating environment.

FIG. 9 is a schematic block diagram of a sample-computing environment.

### DETAILED DESCRIPTION

Efficient temporal search range prediction is provided for multiple reference frames motion estimation (MRFME) based on a linear model for motion-compensated residue. For example, gain of searching more or less reference frames in MRFME can be estimated by utilizing the current residue for a given region, pixel, or other portion of a frame. The temporal search range can be determined based on the estimation. Therefore, for a given portion of a frame, the advantage of using a number of previous reference frames for MRFME can be measured over the cost and complexity of MRFME. In this regard, MRFME can be utilized for portions having a gain over a given threshold when MRFME is used. Since MRFME can be computationally intensive (especially as the number of reference frames increases), it can be used over regular ME when it is advantageous according to the gain threshold.

In one example, the MRFME can be utilized over regular ME when the gain is at or above a threshold; however, in another example, the number of reference frames used in MRFME for a given portion can be adjusted based on a gain calculation of MRFME for the number of reference frames. The number of frames can be adjusted for a given portion to reach an optimal balance of computational intensity and accuracy or performance in encoding/decoding, for example. Moreover, the gain can relate to an average peak signal-to-noise ratio (PSNR) of MRFME (or a number of reference frames utilized in MRFME) relative to that of regular ME or a shorter temporal search range (e.g., a lesser number of reference frames utilized in MRFME), for example.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

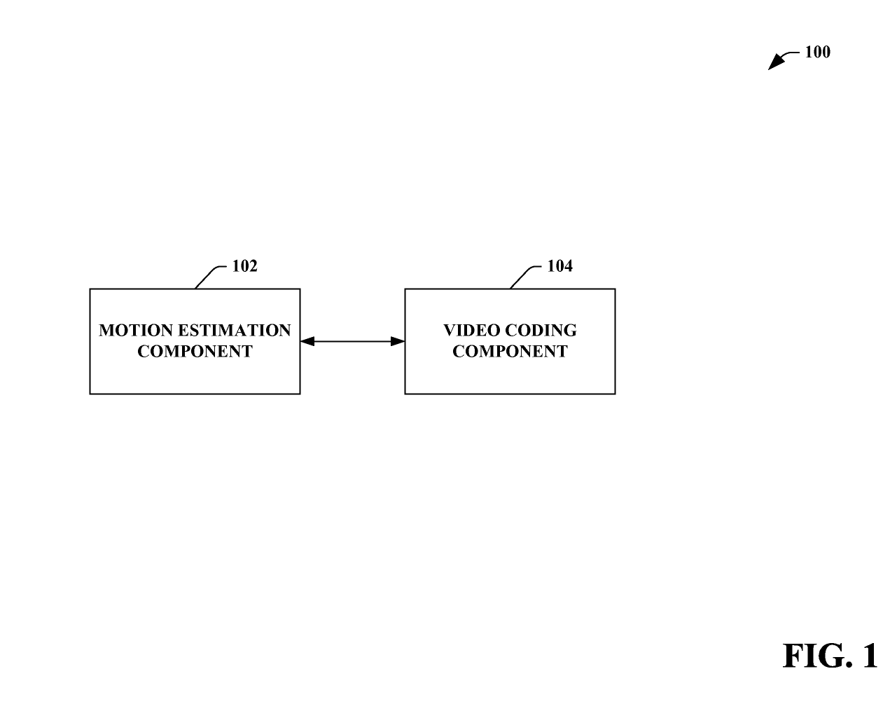

Now turning to the figures, FIG. 1 illustrates a system 100 that facilitates estimating motion for digitally encoding/decoding video. A motion estimation component 102 is provided that can utilize one or more reference frames to predict a video block and a video coding component 104 that encodes/decodes video to/from a digital format based at least in part on the predicted block. It is to be appreciated that a block can be, for example, a pixel, a collection of pixels, or substantially any portion of a video frame. For example, upon receiving a frame or block for encoding, the motion estimation component 102 can evaluate one or more previous video blocks or frames to predict the current video block or frame such that only a prediction error need be encoded. The video coding component 104 can encode the prediction error, which is the motion compensated residue for the block/frame, for subsequent decoding. This can be at least partially accomplished by using the H.264 coding standard in one example.

By utilizing the H.264 coding standard, functionalities of the standard can be leveraged while increasing efficiency through aspects described herein. For example, the video coding component 104 can utilize the H.264 standard to select variable block sizes for motion estimation by the motion estimation component 102. Selecting the block sizes can be performed based on a configuration setting, an inferred performance gain of one block size over others, etc. Moreover, the H.264 standard can be used by the motion estimation component 102 to perform MRFME. In addition, the motion estimation component 102 can calculate gain of performing MRFME using a number of reference frames and/or performing regular ME (with one reference frame) for given blocks to determine motion estimation. As mentioned, MRFME can be computationally intensive as the number of reference frames utilized (e.g., temporal search range) increases, and sometimes such increasing in the number of frames used only provides a small benefit in predicting motion. Thus, the motion estimation component 102 can balance computational intensity of temporal search ranges in MRFME with accuracy and/or performance based on the gain, hereinafter referred to as MRFGain, to provide efficient motion estimation for a given block.

In one example, the MRFGain can be calculated by the motion estimation component 102 based at least in part on motion-compensated residue of a given block. As mentioned, this can be the prediction error for a given block based on the ME or MRFME chosen. For example, where the MRFGain for searching multiple reference frames of a video block is small, the process of utilizing the additional previous reference frames can yield a small performance improvement while providing high complexity in computation. In this regard, it can be more desirable to utilize a smaller temporal search range. Conversely, where the MRFGain of a video block is large (or beyond a certain threshold, for example), increasing the temporal search range can yield a greater benefit to justify the increase in computation complexity; in this case, a larger temporal search range can be utilized. It is to be appreciated that the functionalities of the motion estimation component 102 and/or the video coding component 104 can be implemented in a variety of computers and/or electronic components.

In one example, the motion estimation component 102, video coding component 104, and/or the functionalities thereof, can be implemented in devices utilized in video editing and/or playback. Such devices can be utilized, in an example, in signal broadcasting technologies, storage technologies, conversational services (such as networking technologies, etc.), media streaming and/or messaging services, and the like, to provide efficient encoding/decoding of video to minimize bandwidth required for transmission. Thus, more emphasis can be placed on local processing power to accommodate lower bandwidth capabilities, in one example.

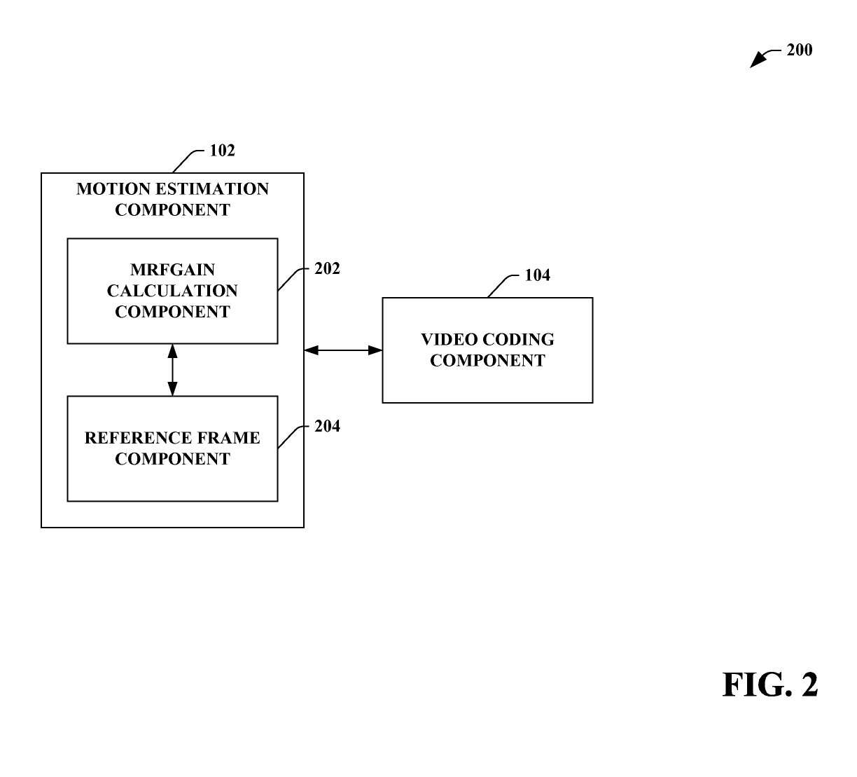

Referring to FIG. 2, a system 200 for calculating gain of utilizing MRFME with a number of reference frames is shown. A motion estimation component 102 is provided to predict video blocks and/or motion-compensation residue for the blocks; a video coding component 104 is also provided to encode the frames or blocks of the video (e.g., as a prediction error in ME) for transmission and/or decoding. The motion estimation component 102 can include an MRFGain calculation component 202 that can determine a measurable advantage of using one or more reference frames, from the reference frame component 204, in estimating motion for a given video block. For example, when receiving video blocks or frames to be predicted by motion estimation, the MRFGain calculation component 202 can determine a gain of utilizing ME or MRFME (and/or a number of reference frames to use in MRFME) to provide efficient motion estimation for the video block. The MRFGain calculation component 202 can leverage the reference frame component 204 to retrieve and/or evaluate the efficiency of using a number previous reference frames.

As described above, the MRFGain calculation component 202 can calculate the MRFGain of shorter and longer temporal search ranges, which the motion estimation component 102 can then utilize in determining a balanced motion estimation considering the performance gain of the chosen estimation as well as its computational complexity. Moreover, as mentioned, the temporal search range can be chosen (and hence the MRFGain can be calculated) based at least in part on a linear model of motion-compensated residue (or prediction error) for a given block or frame.

For example, assuming F is the current frame or block for which video encoding is desired, previous frames can be denoted as {Ref (1), Ref (2), . . . Ref (k), . . . }, where k is the temporal distance between F and reference frame Ref (k). Thus, given a pixel s in F, p(k) can represent the prediction of s from Ref (k). Therefore, the motion-compensated residue, r(k), of s from Ref (k) can be r(k)=s−p(k). Moreover, r(k) can be a random variable with zero-mean and variance σᵣ²(k). Additionally, r(k) can be decomposed as:

r(k)=rₜ(k)+rₛ(k),

where rₜ(k) can be the temporal innovation between F and Ref (k), and rₛ(k) can be the sub-integer pixel interpolation error in the reference frame Ref(k). Thus, representing σᵣ_{ₜ}²(k) and σᵣ_{ₛ}²(k) as the variances of rₜ(k) and rₛ(k) respectively, and assuming that rₜ(k) and rₛ(k) are independent,

σᵣ²(k)=σᵣ_{ₜ}²(k)+σᵣ_{ₛ}²σ(k).

As the temporal distance k increases, so does the temporal innovation between the current frame (e.g., F) and the reference frame (e.g., Ref (k)). Therefore, it can be assumed that σᵣ_{ₜ}²(k) linearly increases with k, giving

σᵣ_{ₜ}²(k)=Cₜ·k,

where Cₜ is the increasing rate of σᵣ_{ₜ}²(k) with respect to k. When an object within a video frame and/or block moves with a non-integer pixel displacement (e.g., non-integer pixel motion) between Ref (k) and F, the sampling positions of the object in F and Ref (k) can be different. In this case, prediction pixels from Ref (k) can be at sub-integer locations, which can require interpolation using pixels at integer positions, resulting in incurrence of sub-integer interpolation error rₛ(k). This interpolation error should not be related to the temporal distance k, however; thus, σᵣ_{ₛ}²(k) can be modeled using a k-invariant parameter Cₛ, thus, σᵣ_{ₛ}²(k)=Cₛ. Therefore, the linear model of motion-compensated residue utilized by the MRFGain calculation component 202 can be:

σᵣ²(k)=Cₛ+Cₜ*k.

Using this linear model, the MRFGain calculation component 202 can determine the MRFGain of utilizing ME, or one or more reference frames from the reference frame component 204 for MRFME, for a given frame or video block in the following manner. A block residue energy can be defined as r̅²̅ (̅k̅)̅, which is r² (k) averaged over the block. Normally, smaller r̅²̅(̅k̅)̅ can indicate better prediction and therefore higher coding performance. In MRFME, if r̅²̅(̅k̅+̅1̅)̅, which is block residue energy of the frame prior in time to frame Ref(k), is smaller than r̅²̅ (̅k̅)̅, searching more reference frames can improve performance in MRFME.

Subsequently, r̅ₜ̅²̅(̅k̅)̅ and r̅ₛ̅²̅(̅k̅)̅ can be defined, which are rₜ²(k) and rₛ²(k) averaged over the block respectively. As rₛ(k) and rₜ(k) are independent, as assumed above in the linear model, r̅²̅(̅k̅)̅≈ r̅ₛ̅²̅(̅k̅)̅+ r̅ₜ̅²̅(̅k̅)̅. In determining MRFGain, the MRFGain calculation component 202 can investigate the behaviors of r̅ₜ̅²̅(̅k̅)̅ and r̅ₛ̅²̅(̅k̅)̅ with increasing k, to obtain an efficient number of reference frames to utilize in ME or MRFME, as follows. When the temporal distance increases, the temporal innovation between frames can increase as well; thus, rₜ(k+1) can have larger amplitude than rₜ(k), which can indicate r̅ₜ̅²̅(̅k̅+̅1̅)̅> r̅ₜ̅²̅(̅k̅)̅. Conversely, the object in the current frame F can, in some cases, have non-integer pixel motion with respect to Ref(k), but integer pixel motion with respect to Ref (k+1). In this case, while there is sub-integer pixel interpolation error in r(k), (e.g., r̅ₛ̅²̅(̅k̅)̅>0), the interpolation error in r(k+1) is zero (e.g., r̅ₛ̅²̅(̅k̅+̅1̅)̅=0). Assuming the object in F has integer pixel motion with respect to Ref(k+1), r̅ₛ̅²̅(̅k̅+̅1̅)̅=0. Thus, when extending temporal search range from Ref(k) to Ref(k+1), assuming Δₜ= r̅ₜ̅²̅(̅k̅+̅1̅)̅− r̅ₜ̅²̅(̅k̅)̅ and Δs= r̅ₛ̅²̅(̅k̅)̅, the increase of residue energy Δ(k) can be

$$\begin{matrix}Δ ( k ) = \overline{{r}^{2} ( k + 1 )} - \overline{{r}^{2} ( k )} \\ = ( \overline{{r}_{t}^{2} ( k + 1 )} - \overline{{r}_{t}^{2} ( k )} ) + ( \overline{{r}_{s}^{2} ( k + 1 )} - \overline{{r}_{s}^{2} ( k )} ) \\ = ( \overline{{r}_{t}^{2} ( k + 1 )} - \overline{{r}_{t}^{2} ( k )} ) + ( 0 - \overline{{r}_{s}^{2} ( k )} ) \\ = {Δ}_{t} ( k ) - {Δ}_{s} ( k ) .\end{matrix}$$

In this case, if Δₜ(k)<Δₛ(k), Δ(k) would be negative, which can mean that searching one more reference frame Ref(k+1) from the reference frame component 204 results in smaller residue energy, and therefore, improved coding performance by the video coding component 104. Furthermore, for large Δₛ(k) and small Δₜ(k), large residue energy reduction, and thus large MRFGain, can be achieved by utilizing an additional reference frame in the motion estimation.

In this example, the values of Δₛ(k) and Δₜ(k) are related to the parameters of the linear model provided supra (e.g., Cₛ and Cₜ). Parameter Cₛ can represent the interpolation error variance σᵣ_{ₛ}²(k). Therefore, for a video signal (or block of a signal) with large Cₛ, rₛ(k) can also yield a large amplitude, and thus Δₛ(k)= r̅ₛ̅²̅(̅k̅)̅ can be large as well. With parameter Cₜ as the increasing rate of σᵣ_{ₜ}²(k), for video signals with small Cₜ, σᵣ_{ₜ}²(k) and σᵣ_{ₜ}²(k+1) can be similar; thus, Δₜ(k)= r̅ₜ̅²̅(̅k̅+̅1̅)̅− r̅ₜ̅²̅(̅k̅)̅ can be small. Accordingly, for video signals (or blocks) with large Cₛ and small Cₜ, the corresponding MRFGain can be large. On the contrary, in the case of small Cₛ and large Cₜ, MRFGain can be small. The MRFGain calculation component 202 can determine whether to utilize additional reference frames from the reference frame component 204 for MRFME based at least in part on the MRFGain and/or its relationship to a specified threshold for a given video block.

In an example, once the MRFGain has been determined by the MRFGain calculation component 202, the following temporal search range prediction can be used for blocks or frames in the video. It is to be appreciated that other range predictions can be utilized with the MRFGain; this is just one example to facilitate explanation of using the gain calculation. Assuming MRFME is performed in a time-reverse manner where Ref (1) is the first reference frame to be searched, the estimations of MRFGain, G, can vary for different Ref(k), (e.g., k>1 vs. k=1). For example, assuming the current reference frame is Ref(k)(k>1), and the temporal search on this frame is complete, to determine if the next reference frame Ref(k+1) should be searched, Cₛ and Cₜ can be estimated from the available information r̅²̅(̅k̅−̅1̅)̅ and r̅²̅(̅k̅)̅. Statistically r̅²̅(̅k̅)̅ converges to σᵣ²(k); therefore, r̅²̅(̅k̅)̅ can be the estimation of σᵣ²(k). Substituting r̅²̅(̅k̅−̅1̅)̅=σᵣ²(k−1) and r̅²̅ (̅k̅)̅=σᵣ²(k) into the linear model of motion-compensated residue given above, parameters Cₛ and Cₜ can be easily obtained, and the corresponding G=Cₛ/Cₜ is

$$G = \frac{k \cdot \overline{{r}^{2} ( k - 1 )} - ( k - 1 ) \cdot \overline{{r}^{2} ( k )}}{\overline{{r}^{2} ( k )} - \overline{{r}^{2} ( k - 1 )}} .$$

If the current reference frame is Ref(1)(k=1), however, r̅²̅(̅k̅−̅1̅)̅ is not available, so Cₛ and Cₜ cannot be calculated using the above formula. In this case, r̅²̅(̅1̅)̅ and the mean of residues in the block r̅(̅1̅)̅ can be evaluated to estimate the MRFGain, G. As sub-integer pixel interpolation filter is a low-pass filter (LF), it cannot recover the high frequency (HF) component in the reference frame so that the HF of the current block cannot be compensated. As a result, the interpolation error can have a small LF component and a large HF component. Therefore, if r̅(̅1̅)̅ is small and r̅²̅(̅1̅)̅ is large (e.g., the residue has small LF component and large HF component), the dominant component in the residue can be rₛ(k) yielding a large Cₛ and small Cₜ (e.g., large G) in this case. Hence, G can be estimated using

$$G = γ \cdot \frac{\overline{{r}^{2} ( 1 )}}{{( \overline{r ( 1 )} )}^{2}} ,$$

where factor γ is tuned from training data. In some examples, a fixed value of γ can be used (such as γ=6) for different sequence.

To determine whether the MRFGain is sufficient for a given reference frame utilization factor in MRFME, the value of G can be compared with a predefined threshold T_{G}. If G is larger than T_{G}(G>T_{G}), it can be assumed that searching more reference frames will improve the performance, so ME can continue with Ref(k+1). However, if G≦T_{G}, MRFME of the current block can terminate, and the rest of the reference frames will not be searched. It is to be appreciated that the higher the T_{G}, the more computation is saved; the lower the T_{G}, the less performance drop is achieved. The MRFGain calculation component 202, or another component can appropriately tune the threshold to achieve a desired performance/complexity balance.

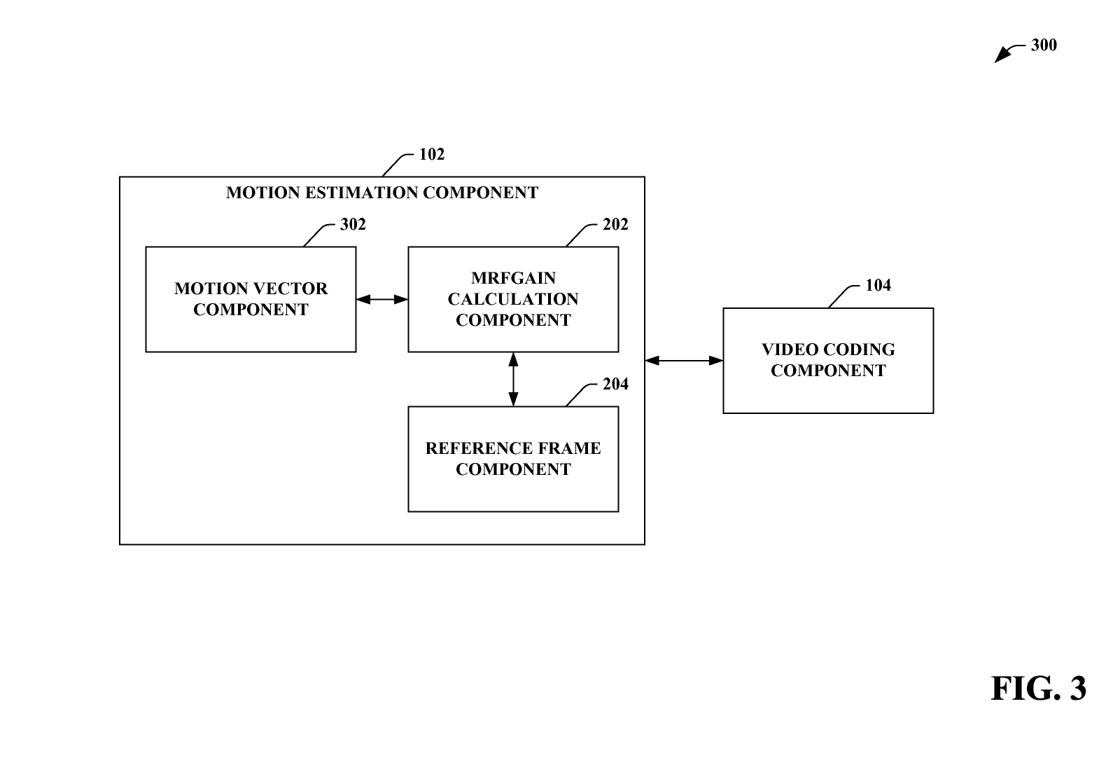

Turning now to FIG. 3, a system 300 for predicting residue and accordingly adjusting a motion estimation reference frame temporal search is displayed. Provided are a motion estimation component 102 that can leverage ME or MRFME with variable reference frame utilization to estimate motion of one or more video blocks or portions of one or more video frames and a video coding component 104 that can encode the video block (or information related thereto, such as a predicted error) based on the motion estimation. Additionally, the motion estimation component 102 can include an MRFGain calculation component 202 that can determine an advantage of utilizing one or more reference frames for the reference frame component 204 in a temporal search range for estimating a video block over a computation cost thereof, as explained above, and a motion vector component 302 that can additionally or alternatively be used to determine the temporal search range.

According to an example, the MRFGain calculation component 202 can determine MRFGain of one or more temporal search ranges of reference frames from reference frame component 204 based on the calculations shown supra. Additionally, the motion vector component 302 can also determine an optimal temporal search range for a video block in some cases. For example, for a reference frame Ref(k) related to a current frame F, the motion vector component 302 can attempt to locate a motion vector MV(k). If the best motion vector MV(k) found is an integer pixel motion vector, it can be assumed that the object in the video block has integer motion between Ref (k) and F. Since there is no sub-pixel interpolation error in r̅²̅ (̅k̅)̅, it can be difficult to find a better prediction in the rest reference frames than that determined by the motion vector component 302. Thus, the motion vector component 302 can be utilized to determine the temporal search range in this instance. Regardless of which component of the motion estimation component 102 determines the temporal search range, the video coding component 104 can encode the information for subsequent storage, transmission, or access, for example.

According to this example, motion can be estimated in the following manner. For k=1 (first reference frame Ref(1)), motion estimation can be performed with respect to Ref(k), and MV(k), r̅²̅(̅1̅)̅ and r̅(̅1̅)̅ can be obtained. Subsequently, G can estimated by the MRFGain calculation component 202 using the formula

$$G = γ \cdot \frac{\overline{{r}^{2} ( 1 )}}{{( \overline{r ( 1 )} )}^{2}} ,$$

provided above. Additionally, the motion vector component 302 can find a best motion vector MV(k) in the reference frame for the video block. If G≦T_{G}(T_{G} being a threshold gain) or MV(k) is an integer pixel motion vector, motion estimation can terminate. If MV(k) is an integer pixel motion vector, it can be used to determine the temporal search range, otherwise, G≦T_{G} and the temporal search range is simply the first reference frame. The video coding component 104 can utilize this information to encode the video block as described above.

However, if G>T_{G} or MV(k) is not an integer pixel motion vector, the MRFGain calculation component 202 can move to the next frame setting k=k+1. Motion estimation can be performed with respect to Ref (k), and again MV(k) and r̅²̅(̅k̅)̅ can be obtained for this prior frame. Subsequently, G can be estimated using to other formula provided above:

$$G = \frac{k \cdot \overline{{r}^{2} ( k - 1 )} - ( k - 1 ) \cdot \overline{{r}^{2} ( k )}}{\overline{{r}^{2} ( k )} - \overline{{r}^{2} ( k - 1 )}} .$$

Again, the motion vector component 302 can find a best motion vector MV(k) in the reference frame. If G>T_{G} or MV(k) is not an integer pixel motion vector, the MRFGain calculation component 202 can move to the next frame setting k=k+1 and repeat this step. If G≦T_{G} or MV(k) is an integer pixel motion vector, MRFME of the current block can terminate. If MV(k) is an integer pixel motion vector, it can be used to determine the temporal search range, otherwise, G≦T_{G} and the temporal search range is the number of frames evaluated. It is to be appreciated that a maximum number of frames can be configured for searching to achieve desired efficiency as well.

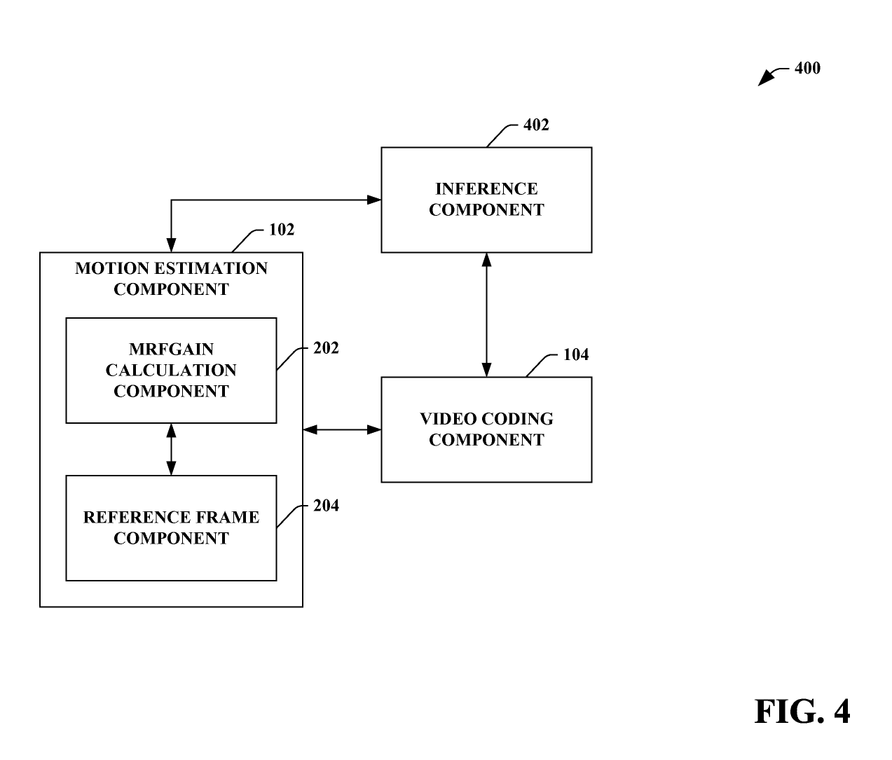

Referring now to FIG. 4, a system 400 that facilitates determining gain of MRFME using one or more reference frames for video encoding is shown. A motion estimation component 102 is provided that can predict a video block based on an error for encoding via a provided video coding component 104. The motion estimation component 102 can include an MRFGain calculation component 202 that can determine a gain of utilizing ME or MRFME, and a number of reference frames to use in the latter case, and a reference frame component 204 from which the MRFGain calculation component 202 can retrieve the reference frames for its calculation. Moreover, an inference component 402 is shown that can provide inference technology to motion estimation component 102, a component thereof, and/or the video coding component 104. Though pictured as a separate component, it is to be appreciated that the inference component 402, and/or functionalities thereof, can be implemented within one or more of the motion estimation component 102, a component thereof, and/or the video coding component 104.

In one example, the MRFGain calculation component 202 can determine a temporal search range for a given video block for motion estimation as described supra (e.g., using the reference frame component 204 to obtain reference frames and performing calculations to determine the gain). According to an example, the inference component 402 can be utilized to determine a desired threshold (such as T_{G} from the examples above). The threshold can be inferred based at least in part of one or more of a video/block type, video/block size, video source, encoding format, encoding application, prospective decoding device, storage format or location, previous thresholds for similar videos/blocks or those having similar characteristics, desired performance statistics, available processing power, available bandwidth, and the like. Moreover, the inference component 402 can be utilized to infer a maximum reference frame count for MRFME based in part on previous frame counts, etc.

Moreover, the inference component 402 can be leveraged by the video coding component 104 to infer an encoding format utilizing motion estimation from the motion estimation component 102. Additionally, the inference component 402 can be used to infer a block-size to send to the motion estimation component 102 for estimation, which can be based on similar factors to those used to determine a threshold, such as encoding format/application, suspected decoding device or capabilities thereof, storage format and location, available resources, etc. The inference component 402 can also be utilized in determining location or other metrics regarding a motion vector, and the like.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

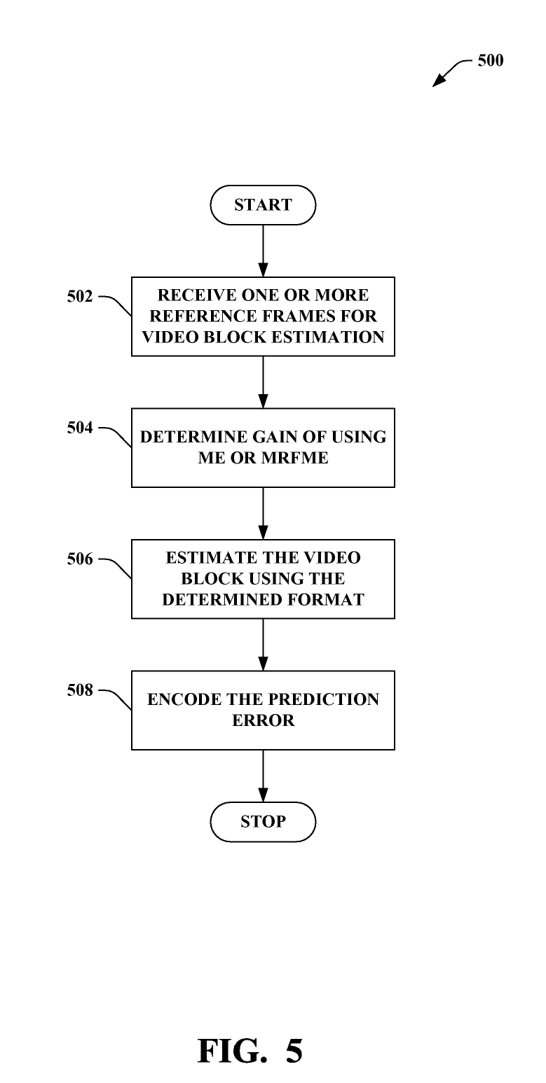

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 5 shows a methodology 500 for motion estimation of a video block based on determining a gain of using ME or MRFME with a number of reference frames. At 502, one or more reference frames can be received for video block estimation. The reference frames can be previous frames related to a current video block to be estimated. At 504, the gain of using ME or MRFME can be determined; this can be calculated as provided supra, for example. The gain for MRFME can be determined according to a number of reference frames calculated to achieve a threshold representing a desired balance between performance and computational complexity, for example, where more than one reference frame is determined to be used. At 506, the video block can be estimated using the determined format, ME or MRFME. If MRFME is used, a number of frames satisfying the gain threshold can be utilized in the estimation. A motion-compensated residue can be determined, for example, based on the estimation, and the prediction error can be encoded at 508.

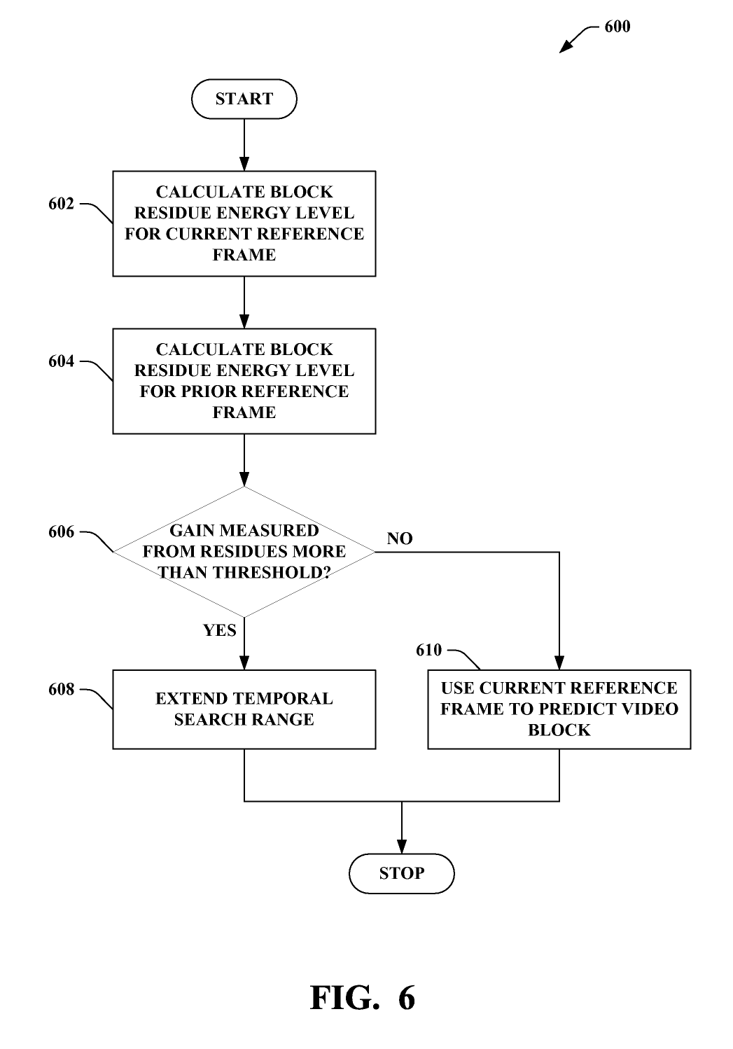

FIG. 6 illustrates a methodology 600 that facilitates determining a range of a temporal search for estimating motion in one or more video blocks. At 602, the residue energy level of a current reference frame (or block thereof), which can be a previous frame from a video block to be encoded, can be calculated. The calculation can represent residue energy as averaged over the block (e.g., for each pixel within the block). It is to be appreciated that a low residue energy across the block can indicate that a better prediction can be made for the block, and therefore a higher coding performance. At 604, a residue energy level can be calculated for a reference frame prior in time to the current reference frame; again, this can be residue energy averaged across a relevant block.

By comparing the residue energy for the current reference frame of the block and a prior reference frame, a performance decision can be made on whether or not to extend the temporal search range to include more prior reference frames for block prediction. At 606, it is determined if a gain measured from the residue energy levels for the current and previous frame(s) is more than (or equal to, in one example) that of a threshold gain (e.g., configured, inferred, or otherwise predetermined). If so, at 608 the temporal search range can be extended for MRFME by adding additional reference frames. It is to be appreciated that the method can return to 602 to start again, and compare the residue level of a frame prior to the prior frame and so on. If the gain measured from the residue energy levels is not higher than the threshold, then at 610 the current reference frame is used to predict the video block. Again, if the method had continued and added more than one additional prior reference frames, substantially all of the prior reference frames added could be used at 610 to predict the video block.

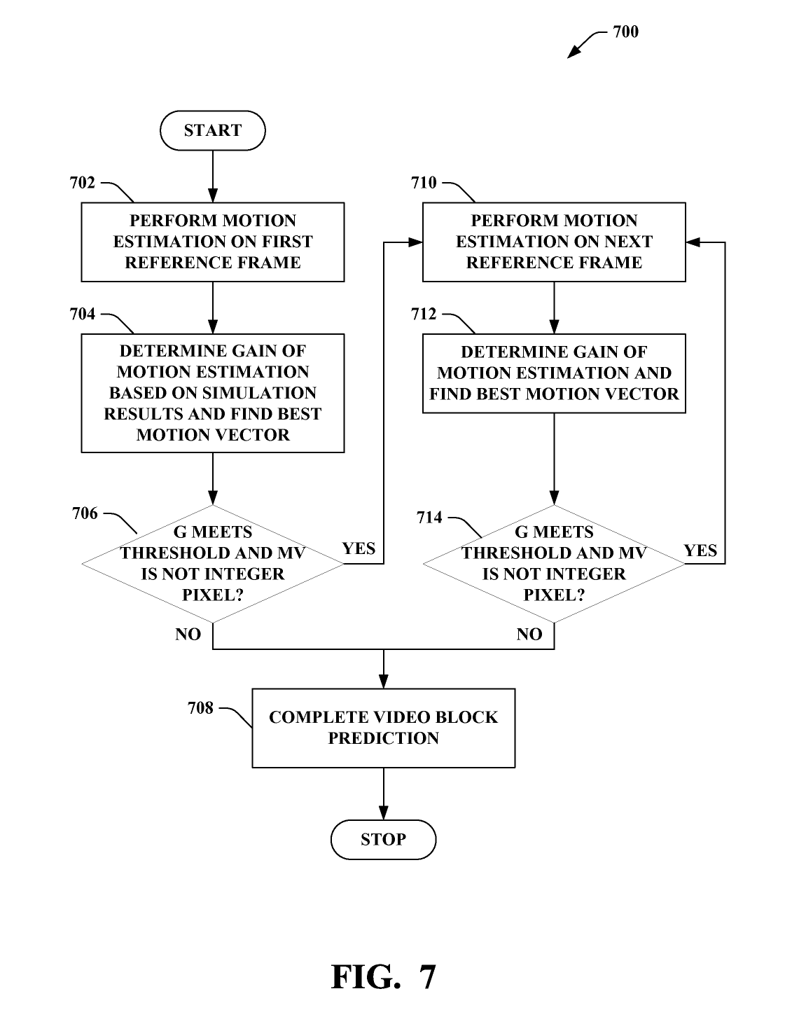

FIG. 7 shows a methodology 700 for efficient block-level temporal search range predicting based at least in part on a gain estimation of the given block. At 702, motion estimation can be performed on a first reference frame for a given video block. The reference frame can be one preceding the current video block in time, for example. At 704, a gain of motion estimation using an additional reference frame can be determined for the block based on previous simulation results, for example, and a best motion vector in the video block can be located. The gain of motion estimation based on simulation results can be determined using the formulas described supra in one example. At 706, a determination can be made was to whether the gain, G, meets a threshold gain (which can indicate another reference frame should be used in the block prediction to achieve a performance/computational complexity balance) and whether or not the motion vector is an integer pixel motion vector. If G does not meet the threshold or the motion vector is an integer pixel motion vector, then at 708, the video block prediction can be completed.

If, however, G does meet the threshold and the motion vector is not an integer pixel motion vector, then at 710, motion estimation can be performed on a next reference frame (e.g., a next prior reference frame). At 712, the gain of motion estimation with the next prior reference frame and the first reference frame can be determined as well as a best motion vector of the next prior reference frame. The gain can be determined using the formulas provided supra where the calculation is based at least in part on the gain received from using the first frame in motion estimation. At 714, if the gain, G, meets the threshold gain explained above and the motion vector is not an integer pixel motion vector, then an additional reference frame can be utilized in the MRFME continuing at 710. If, however, G does not meet the threshold or the motion vector is an integer pixel motion vector, then at 708, the video block prediction can complete using the reference frames. In this regard, complexity caused by MRFME will only be used where it will result in a desired performance gain.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

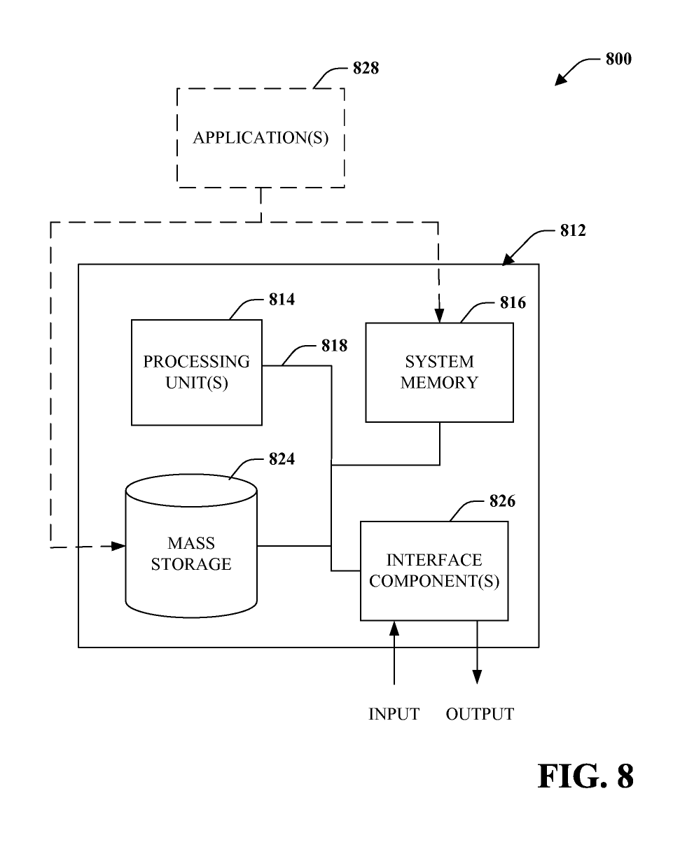

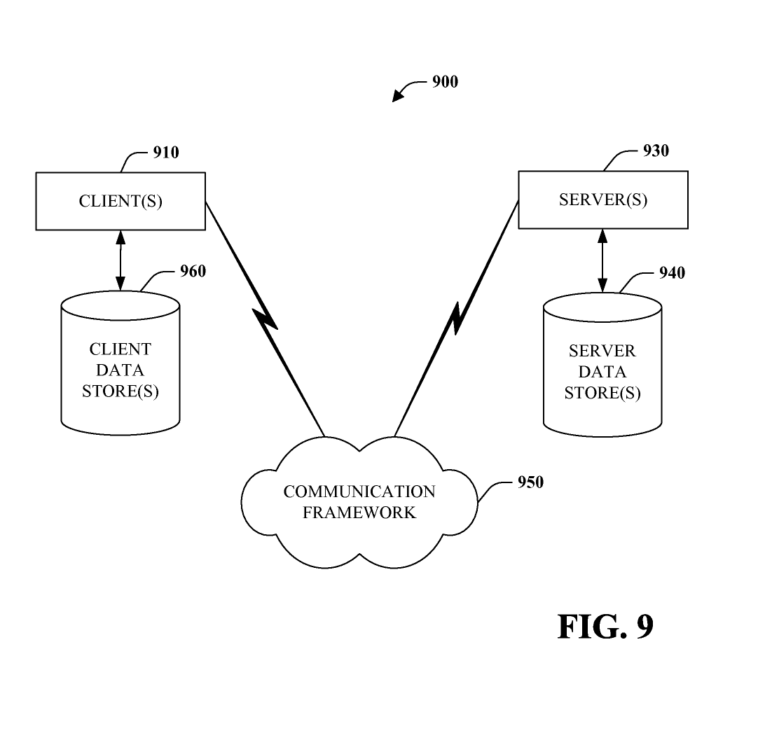

In order to provide a context for the various aspects of the disclosed subject matter, FIGS. 8 and 9 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 8, an exemplary environment 800 for implementing various aspects disclosed herein includes a computer 812 (e.g., desktop, laptop, server, hand held, programmable consumer or industrial electronics . . . ). The computer 812 includes a processing unit 814, a system memory 816 and a system bus 818. The system bus 818 couples system components including, but not limited to, the system memory 816 to the processing unit 814. The processing unit 814 can be any of various available microprocessors. It is to be appreciated that dual microprocessors, multi-core and other multiprocessor architectures can be employed as the processing unit 814.

The system memory 816 includes volatile and nonvolatile memory. The basic input/output system (BIOS), containing the basic routines to transfer information between elements within the computer 812, such as during start-up, is stored in nonvolatile memory. By way of illustration, and not limitation, non-volatile memory can include read only memory (ROM). Volatile memory includes random access memory (RAM), which can act as external cache memory to facilitate processing.

Computer 812 also includes removable/non-removable, volatile/non-volatile computer storage media. FIG. 8 illustrates, for example, mass storage 824. Mass storage 824 includes, but is not limited to, devices like a magnetic or optical disk drive, floppy disk drive, flash memory or memory stick. In addition, mass storage 824 can include storage media separately or in combination with other storage media.

FIG. 8 provides software application(s) 828 that act as an intermediary between users and/or other computers and the basic computer resources described in suitable operating environment 800. Such software application(s) 828 include one or both of system and application software. System software can include an operating system, which can be stored on mass storage 824, that acts to control and allocate resources of the computer system 812. Application software takes advantage of the management of resources by system software through program modules and data stored on either or both of system memory 816 and mass storage 824.

The computer 812 also includes one or more interface components 826 that are communicatively coupled to the bus 818 and facilitate interaction with the computer 812. By way of example, the interface component 826 can be a port (e.g., serial, parallel, PCMCIA, USB, FireWire . . . ) or an interface card (e.g., sound, video, network . . . ) or the like. The interface component 826 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 812 to output device(s) via interface component 826. Output devices can include displays (e.g., CRT, LCD, plasma . . . ), speakers, printers and other computers, among other things.

FIG. 9 is a schematic block diagram of a sample-computing environment 900 with which the subject innovation can interact. The system 900 includes one or more client(s) 910. The client(s) 910 can be hardware and/or software (e.g., threads, processes, computing devices). The system 900 also includes one or more server(s) 930. Thus, system 900 can correspond to a two-tier client server model or a multi-tier model (e.g., client, middle tier server, data server), amongst other models. The server(s) 930 can also be hardware and/or software (e.g., threads, processes, computing devices). The servers 930 can house threads to perform transformations by employing the aspects of the subject innovation, for example. One possible communication between a client 910 and a server 930 may be in the form of a data packet transmitted between two or more computer processes.

The system 900 includes a communication framework 950 that can be employed to facilitate communications between the client(s) 910 and the server(s) 930. Here, the client(s) 910 can correspond to program application components and the server(s) 930 can provide the functionality of the interface and optionally the storage system, as previously described. The client(s) 910 are operatively connected to one or more client data store(s) 960 that can be employed to store information local to the client(s) 910. Similarly, the server(s) 930 are operatively connected to one or more server data store(s) 940 that can be employed to store information local to the servers 930.

By way of example, one or more clients 910 can request media content, which can be a video for example, from the one or more servers 930 via communication framework 950. The servers 930 can encode the video using the functionalities described herein, such as ME or MRFME calculating gain of utilizing one or more reference frames to predict blocks of the video, and store the encoded content (including error predictions) in server data store(s) 940. Subsequently, the server(s) 930 can transmit the data to the client(s) 910 utilizing the communication framework 950, for example. The client(s) 910 can decode the data according to one or more formats, such as H.264, utilizing the error prediction information to decode frames of the media. Alternatively or additionally, the client(s) 910 can store a portion of the received content within client data store(s) 960.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for providing motion estimation in video coding, comprising:
a reference frame component that provides a plurality of reference frames related to a video block; and
a gain calculation component that determines a current temporal search range for motion estimation (ME) or multiple reference frame ME (MRFME) based at least in part on calculating a performance gain of utilizing one or more of the plurality of reference frames based at least in part on a residue energy thereof.

2. The system of claim 1, further comprising a video coding component that encodes a motion-compensated residue based at least in part on the video block predicted by utilizing ME or MRFME with the current temporal search range.

3. The system of claim 1, further comprising a motion vector component that calculates a best motion vector for the video block, the motion vector is used to determine the current temporal search range where it is an integer pixel motion vector.

4. The system of claim 1, the residue energy σᵣ²(k) for one or more of the plurality of reference frames is calculated, where k is a size of the temporal search range, Cₜ is an increasing rate of a variant of temporal innovation between the video block and one of the plurality of reference frames, and Cₛ is a k-invariant parameter, based at least in part on a linear residue model σᵣ²(k)=Cₛ+Cₜ*k.

5. The system of claim 4, the performance gain, G, is calculated using
$$G = γ \cdot \frac{\overline{{r}^{2} ( 1 )}}{{( \overline{r ( 1 )} )}^{2}} ,$$
where r̅²̅(̅1̅)̅ is a mean squared residue corresponding to a first reference frame, r̅(̅1̅)̅ is a mean average of residues in the video block, and γ is a configured parameter.

6. The system of claim 5, further comprising an inference component that infers a value for γ based at least in part on simulation results or previous gain calculations.

7. The system of claim 4, the gain calculation component further calculates a performance gain of utilizing a larger temporal search range, comprising additional reference frames, for MRFME.

8. The system of claim 7, the performance gain of utilizing a larger temporal search range is calculated, where r̅²̅(̅k̅−̅1̅)̅ is a mean squared residue corresponding to reference frame k−1, and r̅²̅(̅k̅)̅ is a mean squared residue corresponding to reference frame k, using
$$G = \frac{k \cdot \overline{{r}^{2} ( k - 1 )} - ( k - 1 ) \cdot \overline{{r}^{2} ( k )}}{\overline{{r}^{2} ( k )} - \overline{{r}^{2} ( k - 1 )}} .$$

9. A method for estimating motion in predictive video block encoding, comprising:
calculating a gain of performance of using one or more previous reference frames in predicting a video block;
determining a temporal search range comprising a number of reference frames to utilize in motion estimation based on the calculated performance gain; and
predicting the video block utilizing the temporal search range of reference frames to estimate motion in the video block.

10. The method of claim 9, further comprising calculating a best motion vector for the video block, the motion vector is used to determine the temporal search range where it is an integer pixel motion vector.

11. The method of claim 9, wherein the calculating includes calculating the performance gain based at least in part on evaluating residue energy of the one or more previous reference frames.

12. The method of claim 11, wherein the calculating includes calculating the residue energy, σᵣ²(k), for at least one of the previous reference frames, where k is a size of the temporal search range, Cₜ is an increasing rate of a variant of temporal innovation between the video block and the at least one previous reference frame, and Cₛ is a k-invariant parameter, based at least in part on a linear residue model σᵣ²(k)=Cₛ+Cₜ*k.

13. The method of claim 12, wherein the calculating includes calculating the performance gain, G, of using more than one reference frame for motion estimation using
$$G = γ \cdot \frac{\overline{{r}^{2} ( 1 )}}{{( \overline{r ( 1 )} )}^{2}} ,$$
where r̅²̅(̅1̅)̅ is a mean squared residue corresponding to a first reference frame of the one or more previous reference frames, r̅(̅1̅)̅ is a mean average of residues in the video block, and γ is a configured parameter.

14. The method of claim 13, further comprising inferring a value for γ based at least in part on tuning from simulation results or previous gain calculations.

15. The method of claim 12, wherein the calculating includes calculating the performance gain of utilizing more than a two frame temporal search range, where r̅²̅(̅k̅−̅1̅)̅ is a mean squared residue corresponding to reference frame k−1, and r̅²̅(̅k̅)̅ is a mean squared residue corresponding to reference frame k, using
$$G = \frac{k \cdot \overline{{r}^{2} ( k - 1 )} - ( k - 1 ) \cdot \overline{{r}^{2} ( k )}}{\overline{{r}^{2} ( k )} - \overline{{r}^{2} ( k - 1 )}} .$$

16. The method of claim 15, wherein the calculating includes calculating the performance gain for an increasing temporal search range until the gain fails to meet a specified threshold.

17. The method of claim 16, further comprising inferring the threshold from a desired encoding size.

18. A system for estimating motion in predictive video block encoding, comprising:
means for calculating a performance gain of utilizing single reference frame motion estimation (ME) or multiple reference frame motion estimation (MRFME) for predicting a video block; and
means for utilizing ME or MRFME to predict the video block according to the calculated performance gain.

19. The system of claim 18, further comprising:
means for calculating a performance gain of utilizing a number of reference frames in MRFME or the number of reference frames plus one or more additional reference frames; and
means for utilizing the number of frames yielding gain beyond a threshold in MRFME.

20. The system of claim 18, wherein the performance gain calculation is based at least in part on a linear model of motion-compensated residue of one or more reference frames.
